(19) United States
(12) Patent Application Publication
(10) Pub. No.: US 2023/0384460 A1
(43) Pub. Date: Nov. 30, 2023

(54) SATELLITE SIGNAL RECEPTION APPARATUS, SATELLITE SIGNAL PROCESSING METHOD AND PROGRAM

(71) Applicant: NIPPON TELEGRAPH AND TELEPHONE CORPORATION, Tokyo (JP)

(72) Inventor: Seiji YOSHIDA, Tokyo (JP)

(21) Appl. No.: 18/251,088

(22) PCT Filed: Sep. 28, 2021
(86) PCT No.: PCT/JP2021/035654

§ 371 Date: Apr. 28, 2023

(30) Foreign Application Priority Data
Nov. 18, 2020 (WO) PCT/JP2020/043044
May 28, 2021 (WO) PCT/JP2021/020391

(51) Int. Cl. G01S 19/28; G01S 19/22

(52) U.S. Cl. CPC G01S 19/28; G01S 19/22

(57) ABSTRACT

A satellite signal reception device includes: a signal selection unit configured to select a predetermined number of satellite signals on a basis of reception quality of satellite signals received by a GNSS antenna; and a measurement unit configured to perform positioning or time synchronization using the predetermined number of satellite signals selected by the signal selection unit.

### TECHNICAL FIELD

The present invention relates to techniques for performing positioning and time synchronization by a global navigation satellite system (GNSS) with high accuracy.

### BACKGROUND ART

In recent years, positioning and time synchronization by GNSS have been utilized in a wide range of applications.

In positioning and time synchronization by GNSS, processing of positioning and time synchronization is performed using GNSS satellite signals (hereinafter, satellite signals) received by a GNSS antenna.

There is a case where reception of satellite signals in a line-of-sight state are blocked by a structure or the like that exists around the installation position of the GNSS antenna. In that case, the satellite signals are not received with signal intensity required by the GNSS antenna, or are received as invisible satellite signals by multipath in which signals are reflected and diffracted by a structure or the like that exists around the installation position of the GNSS antenna. As a result, positioning performance and time synchronization performance by GNSS deteriorate.

### PRIOR ART DOCUMENT

### Non Patent Document

Non Patent Document 1: “Localization for Navigation of a Autonomous Mobile Robot Using an Open Source GNSS Library in Pedestrian Environments” by Tsukagoshi et al., Transactions of the Society of Instrument and Control EngineersVol. 52, No. 5, 276/283(2016)

### SUMMARY OF INVENTION

### Technical Problem

In order to improve the accuracy of positioning and time synchronization by GNSS, receiving a large number of visible satellite signals that can be received in a line-of-sight state and effectively excluding invisible satellite signals that cannot be received in a line-of-sight state and greatly affect deterioration in accuracy from satellite signals used in positioning and time synchronization are important.

The present invention has been made in view of the above points, and has an object to provide techniques that enable appropriate selection of satellite signals and positioning and time synchronization by GNSS with high accuracy even in a case where the reception environment of satellite signals is not good.

### Solution to Problem

According to the disclosed techniques, a satellite signal reception device is provided that includes a signal selection unit configured to select a predetermined number of satellite signals on the basis of reception quality of satellite signals received by a GNSS antenna; and a measurement unit configured to perform positioning or time synchronization using the predetermined number of satellite signals selected by the signal selection unit.

### Advantageous Effects of Invention

According to the disclosed techniques, techniques are provided that enable positioning and time synchronization by GNSS with high accuracy even in a case where the reception environment of satellite signals is not good.

### BRIEF DESCRIPTION OF DRAWINGS

FIG. 1 is a configuration diagram of a measurement device according to an embodiment of the present invention.

FIG. 2 is a diagram illustrating an example of a processing procedure regarding selection of satellite signals.

FIG. 3 is a diagram illustrating an example of setting parameters.

FIG. 4 is a diagram illustrating a setting example of GNSS bias values.

FIG. 5 is a diagram illustrating a setting example of elevation angle bias values.

FIG. 6 is a diagram illustrating a setting example of a GNSS priority order.

FIG. 7 is a diagram illustrating a processing procedure regarding setting of bias values.

FIG. 8 is a diagram illustrating maximum values of CNRs of respective groups.

FIG. 9 is a diagram illustrating an example of curve fitting.

FIG. 10 is a diagram illustrating a setting example of bias values.

FIG. 11 is a diagram illustrating how a satellite signal is incident on a wall surface of a building and reflected from the wall surface.

FIG. 12 is a diagram illustrating how a satellite signal is incident on a wall surface of a building and reflected from the wall surface.

FIG. 13 is a diagram illustrating a setting example of a dCNR value that depends on an elevation angle.

FIG. 14 is a diagram illustrating an example of a processing procedure regarding selection of satellite signals.

FIG. 15 is a diagram illustrating an example of setting parameters.

FIG. 16 is a diagram illustrating a processing procedure regarding setting of bias values.

FIG. 17 is a diagram illustrating a setting example of bias values.

FIG. 18 is a diagram illustrating an actual measurement example of reception characteristics in an L1 band.

FIG. 19 is a diagram illustrating an actual measurement example of reception characteristics in an L2 band.

FIG. 20 is a diagram illustrating an example hardware configuration of a device.

### DESCRIPTION OF EMBODIMENTS

Hereinafter, embodiments of the present invention (present embodiments) will be described with reference to the drawings. The embodiments described below are merely examples, and embodiments to which the present invention is applied are not limited to the following embodiments.

### Details of Problem and Description of Embodiments

In recent years, GLONASS, Galileo, BeiDou, QZSS, and the like have been available as navigation satellite systems other than global positioning system (GPS), and the number of satellites has increased.

As described above, in order to improve the accuracy of positioning and time synchronization by GNSS, receiving a large number of visible satellite signals that can be received in a line-of-sight state and effectively excluding invisible satellite signals that cannot be received in a line-of-sight state and greatly affect deterioration in accuracy from satellite signals used in positioning and time synchronization are important.

As a conventional method for excluding invisible satellite signals, a carrier-to-noise ratio (CNR) mask method is known in which satellite signals having CNRs less than or equal to a preset threshold are excluded from received satellite signals.

However, since a CNR value of a satellite signal depends on a gain of the antenna, reception sensitivity of the receiver, a cable loss between the antenna and the receiver, the satellite type, and the like, an optimum threshold is difficult to be set.

Furthermore, in the CNR mask method, in a case where an interference signal is mixed in the signal bandwidth of satellite signals, CNR values of the satellite signals decrease as a whole, and as a result of the satellite signals being lost by the CNR mask, there is a risk that positioning and time synchronization cannot be performed. Examples of such an interference signal include noise generated by a device and an interference signal from another communication system in addition to a GNSS jamming (interruption) signal intentionally generated.

In the present embodiments, in order to receive a large number of visible satellite signals that can be received in a line-of-sight state and effectively exclude invisible satellite signals that cannot be received in a line-of-sight state and greatly affect deterioration in accuracy from satellite signals used in positioning and time synchronization, satellite signals suitable for use in positioning and time synchronization are selected in a procedure to be described below on the assumption of a multi-GNSS environment in which a large number of visible satellites can be secured. This procedure enables selection of satellite signals in which the reception quality of the satellite signals is the basis of the selection and the individual characteristics of antennas and receivers and the influence of an interference signal are excluded.

Hereinafter, examples of specific configurations and operation in the present embodiments will be described in detail. Note that, in the processing described below, a CNR is used as an index of reception quality, but an index of reception quality other than a CNR may be used. Furthermore, in the present embodiments, a “satellite signal” at the time of “selection of a satellite signal” is associated with a GNSS satellite that is a transmission source of the satellite signal. For example, assuming that a GNSS satellite A, a GNSS satellite B, and a GNSS satellite C are three different GNSS satellites of any types, selecting three satellite signals means selecting a satellite signal from the GNSS satellite A, a satellite signal from the GNSS satellite B, and a satellite signal from the GNSS satellite C.

Furthermore, in the present embodiments, elevation angle dependency and GNSS type and frequency band dependency are considered in normalization of a CNR value. Here, the GNSS type means a type of a navigation satellite system such as GPS or GLONASS. The reason for considering elevation angle dependency is that the smaller the elevation angle of the satellite, the longer the propagation path in the troposphere close to the ground surface, and the satellite signal tends to be more attenuated. The reason for considering GNSS type dependency is that the signal frequency and the transmission power differ depending on a GNSS type, and a difference occurs in CNR values. Furthermore, even in the same GNSS type, a difference occurs in CNR values depending on the frequency band of a signal (for GPS, L1 band, L2 band, L5 band, or the like). Note that either the elevation angle dependency or the GNSS type and frequency band dependency may be considered.

Hereinafter, a first embodiment and a second embodiment will be described. In the second embodiment, portions different from those of the first embodiment will be mainly described.

### First Embodiment

(Device Configuration)

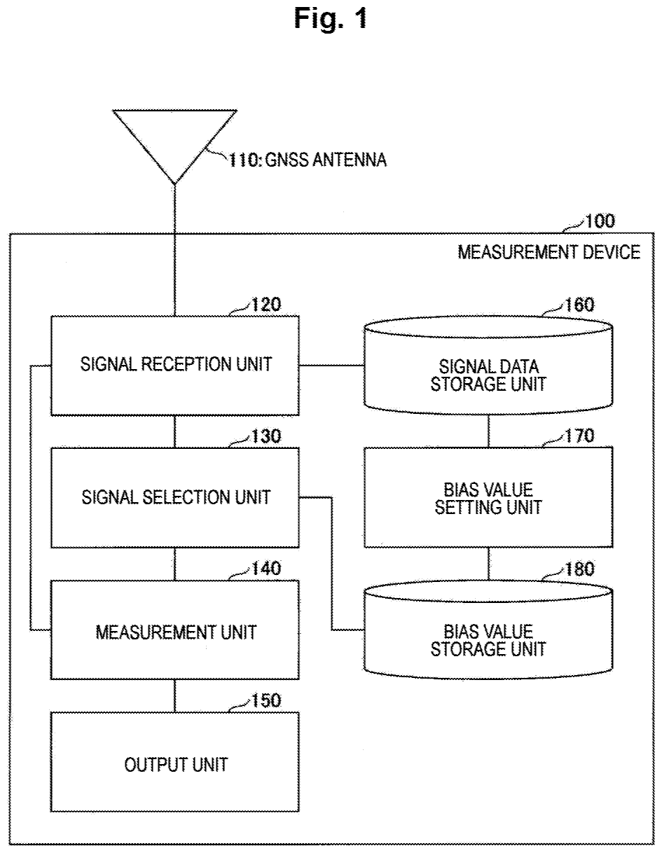

FIG. 1 illustrates a configuration example of a measurement device 100 according to the present embodiment. The measurement device 100 according to the present embodiment includes a GNSS antenna 110, a signal reception unit 120, a signal selection unit 130, a measurement unit 140, an output unit 150, a signal data storage unit 160, a bias value setting unit 170, and a bias value storage unit 180. Note that the measurement device 100 is a device that receives and processes satellite signals, and may be referred to as a “satellite signal reception device”.

The GNSS antenna 110 receives radio waves transmitted from GNSS satellites on an orbit, and converts the radio waves into electric signals. These electric signals may be referred to as “satellite signals”.

The GNSS antenna 110 and the signal reception unit 120 are connected by a cable, and satellite signals are transmitted to the signal reception unit 120 by the cable. In a case where the distance between the GNSS antenna 110 and the signal reception unit 120 is long, an amplifier may be provided between the GNSS antenna 110 and the signal reception unit 120.

The signal reception unit 120 receives satellite signals, measures the CNRs, and identifies the types of GNSS satellites that are the transmission sources of the received satellite signals. Furthermore, the elevation angles are measured using orbit information of the satellites (for example, almanac and ephemeris). The orbit information of the satellites may be acquired from navigation messages of the satellite signals, or may be acquired from other means (for example, a server on a network). The signal reception unit 120 transmits identification information of the received satellite signals (codes such as pseudorandom noise (PRN) numbers), the elevation angles, the CNRs, and the satellite types of the satellite signals to the signal selection unit 130. Furthermore, the signal reception unit 120 stores the identification information, the elevation angles, the CNRs, and the satellite types for the respective received satellite signals in the signal data storage unit 160. Note that an elevation angle is an angle formed using a line of sight and a horizontal plane in a case where a GNSS satellite as a transmission source of a satellite signal is viewed from a reception point of the satellite signal (that is, GNSS antenna). For example, in a case where the GNSS satellite is at the zenith, its elevation angle is 90°.

Types of GNSS satellites to be targeted in the present embodiment are GPS, GLONASS, Galileo, BeiDou, and QZSS. However, these are examples, and may be more or less types than these types.

The signal selection unit 130 selects satellite signals to be used for positioning and time synchronization from a plurality of received satellite signals. A selection procedure will be described below.

The measurement unit 140 performs time synchronization using satellite signals transmitted from GNSS satellites including atomic clocks in which time is precisely managed relative to the absolute time, thereby calculating time information in which time synchronization is performed with high accuracy relative to the absolute time. The absolute time here is, for example, coordinated universal time (UTC). Note that the measurement unit 140 may perform only one of positioning and time synchronization.

Although the absolute time when satellite signals are transmitted from the GNSS satellites can be known from the received satellite signals, accurate absolute time at the reception position cannot be obtained unless propagation time until the satellite signals reach the position of the GNSS antenna 110 from the GNSS satellites is measured and time offset values Δt between the time of the measurement unit 140 and the time of the satellites are corrected.

Therefore, the measurement unit 140 performs positioning and time synchronization at the same time by calculating, by code-based positioning, four parameters of three-dimensional coordinate information of the reception position (x,y,z) and time offsets (Δt), for example, using satellite signals from four or more GNSS satellites. The measurement unit 140 may perform carrier phase-based positioning in addition to code-based positioning.

The measurement unit 140 outputs the time information based on the absolute time and position information as a positioning result via the output unit 150. For example, in a case where the measurement device 100 is a base station in a mobile network, time division duplex (TDD) signals can be transmitted so as not to interfere with an adjacent base station by, for example, time slot configurations (arrangement) of uplink and downlink signals of TDD signal frames being matched with those of the adjacent base station (synchronized with the absolute time), and then transmission timing of the signal frames being synchronized using the time information synchronized with the absolute time by the base station.

The bias value setting unit 170 sets (calculates) bias values using satellite signal data stored in the signal data storage unit 160, and stores the set bias values in the bias value storage unit 180. The bias values stored in the bias value storage unit 180 are used for selection processing of satellite signals in the signal selection unit 130. Details of bias value setting operation by the bias value setting unit 170 will be described below.

The measurement device 100 according to the present embodiment may be one physically integrated device, or may be a device in which some functional units are physically separated and a plurality of the separated functional units are connected by a network.

Furthermore, the measurement device 100 may include all the functions illustrated in FIG. 1, or part of the functions (for example, the signal selection unit 130 and the measurement unit 140) may be provided on a network (for example, on the cloud), and the rest of the functions may be installed in the measurement device 100 and used.

For example, satellite signal selection and positioning calculation may be performed on the cloud by outputting observation data from the signal reception unit 120 included in the measurement device 100 and transmitting the observation data to a device including “the signal selection unit 130 and the measurement unit 140” provided on the cloud. In this case, a positioning calculation result is returned from the measurement unit 140 on the cloud to the output unit 150.

Furthermore, a device including “the signal data storage unit 160 and the bias value setting unit 170” in the measurement device 100 may be provided on a network (for example, on the cloud), and the rest of the functions may be installed in the measurement device 100 and used.

For example, observation data is output from the signal reception unit 120 included in the measurement device 100, and the observation data is stored in the signal data storage unit 160 provided on the cloud, and the bias value setting unit 170 provided on the cloud sets bias values using the stored data. In this case, the bias values are returned from the bias value setting unit 170 on the cloud to the bias value storage unit 180.

### Operation Example of Signal Selection Unit 130

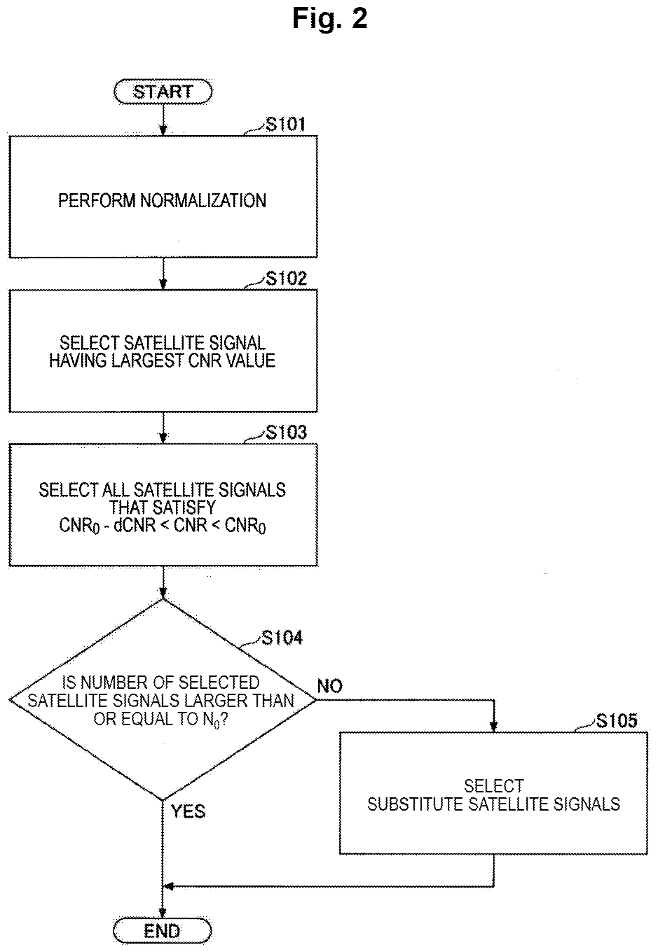

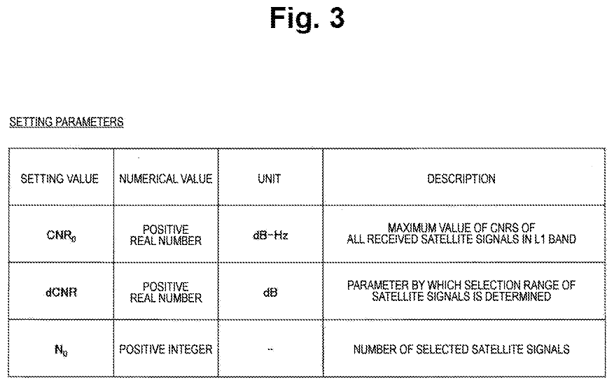

Next, an operation example of the signal selection unit 130 will be described in detail along a procedure of a flowchart illustrated in FIG. 2. In the description of the procedure, reference is also made to FIGS. 3 to 6.

First, setting parameters used in the procedure will be described with reference to FIG. 3. As illustrated in FIG. 3, a CNR₀ is a maximum value of CNRs of all received satellite signals in the L1 band. A dCNR is a parameter by which a selection range of satellite signals is determined. An N₀ is the number of selected satellite signals. Note that performing reception in the L1 band is an example.

In S101 of FIG. 2, the signal selection unit 130 normalizes the CNR values of all satellite signals received in the L1 band in consideration of the GNSS types and the elevation angle dependency. Specifically, normalization is performed by preset GNSS bias values and elevation angle bias values by the bias value setting unit 170 being added to the CNR values obtained by observation.

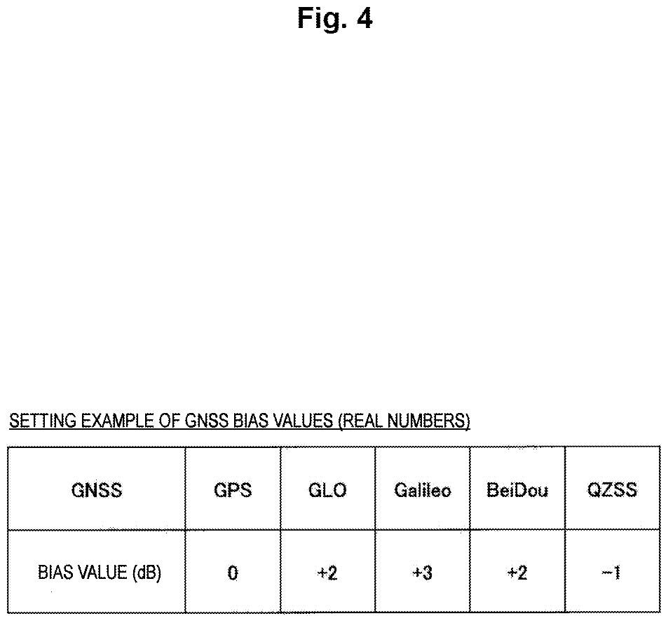

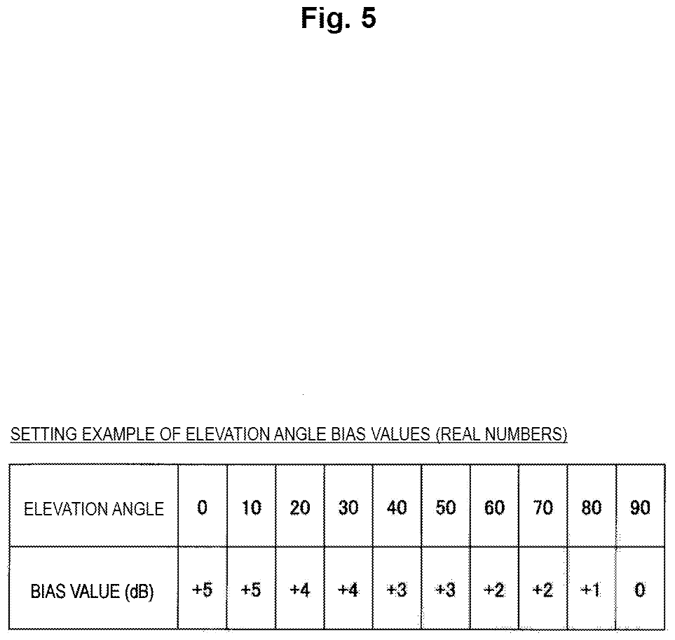

FIG. 4 illustrates a setting example of the GNSS bias values, and FIG. 5 illustrates a setting example of the elevation angle bias values. These bias values are stored in the bias value storage unit 180.

For example, assuming that the CNR value obtained by observing a certain satellite signal is 30 dB-Hz, the elevation angle is 30°, and the satellite type is GLO (GLONASS), the signal selection unit 130 sets a CNR value after correction (after normalization) of the satellite signal to 30+4+2=36 dB-Hz. Hereinafter, a CNR value means a CNR value after normalization.

In S102 of FIG. 2, the signal selection unit 130 selects a satellite signal having the greatest CNR value from all the satellite signals received in the L1 band, and records the CNR value as the CNR₀. Note that, here, it is assumed that there is at least one visible satellite signal as a precondition.

In S103, the signal selection unit 130, for the CNR value (CNR₀) of the satellite signal selected in S102, sets a value dCNR (for example, 10 dB) smaller than the CNR₀ as a lower limit of CNRs, and selects satellite signals that satisfy the condition from the received satellite signals. That is, the signal selection unit 130 selects all satellite signals having CNR values that satisfy CNR₀-dCNR<CNR<CNR₀ from all the satellite signals received in the L1 band.

In S104, the signal selection unit 130 determines whether the number of satellite signals selected in S102 and S103 is greater than or equal to a preset minimum selected satellite signal number (N₀). In a case where the determination result in S104 is Yes, the signal selection processing by the signal selection unit 130 ends. The signal selection unit 130 notifies the measurement unit 140 of identification information of the selected satellite signals (codes such as PRN numbers), and the measurement unit 140 performs positioning and time synchronization using the selected satellite signals.

In a case where the determination result in S104 is No, that is, in a case where the number of the satellite signals selected in S102 and S103 is less than the preset minimum selected satellite signal number (N₀), the processing proceeds to S105.

In S105, the signal selection unit 130 selects satellite signals in order from the satellite signal having the next-greatest CNR value that is less than or equal to “CNR₀-dCNR” on the basis of a preset priority order of GNSS types, and compensates for a lack so that the total number of selected satellite signals reaches No.

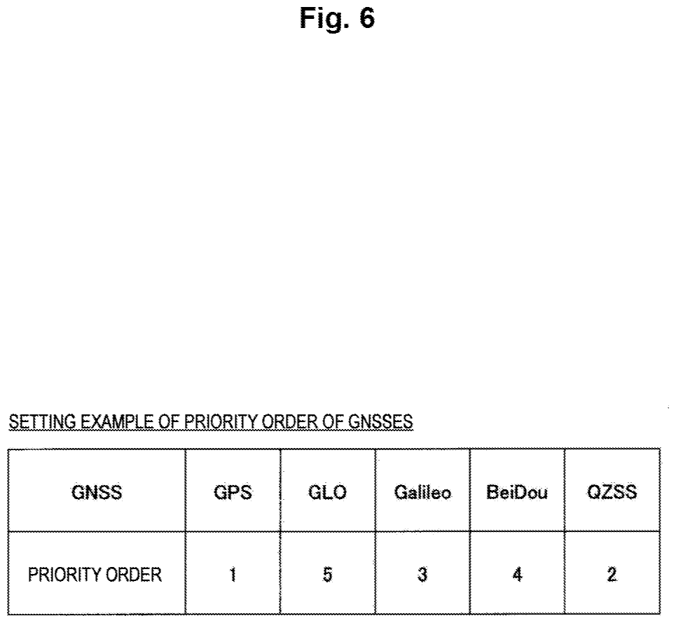

FIG. 6 illustrates a setting example of the priority order of GNSS types. Setting values of the priority order of GNSS types are also stored in the bias value storage unit 180, and the signal selection unit 130 refers to the setting values stored in the bias value storage unit 180. FIG. 6 illustrates that GPS has the highest priority and GLO (GLONASS) has the lowest priority.

Here, selection based on the priority order of GNSS types will be described. For each type of GNSS satellites, there is a difference (clock bias) in time accuracy based on the absolute time of a clock by which the satellite is operated. In a case where a substitute satellite signal is selected in S105, the satellite signal is selected in consideration of the reliability of GNSS including the clock bias.

For example, GPS and QZSS are completely synchronized in time as navigation satellite systems and the clock bias is small, and thus can be classified as a category 1, Galileo can be classified as a category 2, and GLONASS and BeiDou can be classified as a category 3. On the basis of such category classification, the priority order as illustrated in FIG. 6 is set.

As a method for selecting a substitute satellite signal in consideration of the priority order based on the reliability as described above, for example, there is a method for setting premiums (values to be added) to CNR values according to the priority order (or category of the reliability) and sequentially selecting the required number of satellite signals from the satellite signal having the greatest CNR value.

For example, in the example of FIG. 6, the premium of a priority order 1 is 5, the premium of a priority order 2 is 4, the premium of a priority order 3 is 3, the premium of a priority order 4 is 2, and the premium of a priority order 5 is 1.

As an example, it is assumed that the N₀ is 5, and three satellite signals are selected in S102 and S103. Furthermore, assuming that there are a satellite signal 1 (CNR value=26 dB-Hz, premium=1), a satellite signal 2 (CNR value=25 dB-Hz, premium=3), and a satellite signal 3 (CNR value=24 dB-Hz, premium=5) as satellite signals having CNR values less than or equal to “CNR₀-dCNR”, in S105, the signal selection unit 130 selects the satellite signal 3 and the satellite signal 2 having CNR values of 29 dB-Hz and 28 dB-Hz to which premiums are added.

### Operation Example Regarding Bias Value Setting

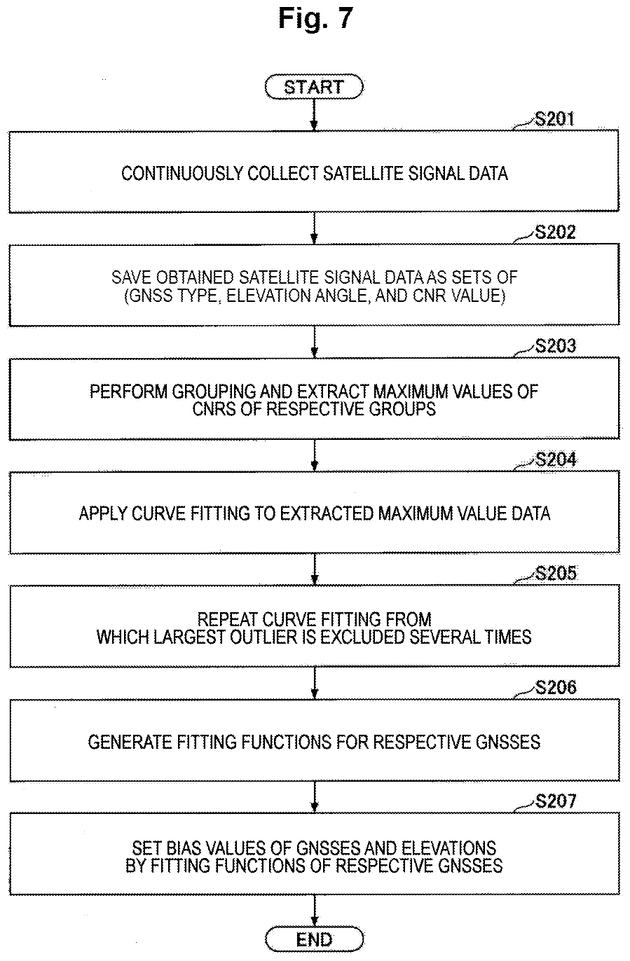

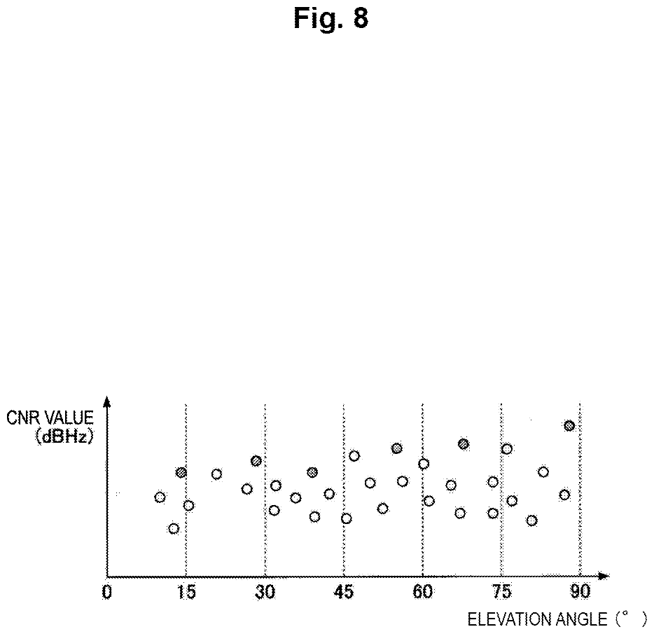

Next, an operation example for setting bias values will be described in detail along a procedure of a flowchart illustrated in FIG. 7. In the description of the procedure, reference is also made to FIGS. 8 to 10.

In S201, the signal reception unit 120 continuously collects satellite signal data. Regarding the collection time length, in a case of an open sky environment, collecting data continuously for 24 hours is sufficient. In other reception environments, continuous collection for a longer term is required. The data may be collected at any time and the bias values may be updated.

In S202, the collected satellite signal data is stored in the signal data storage unit 160 as sets of (a GNSS type, an elevation angle, and a CNR value).

In S203, the bias value setting unit 170 groups data in which GNSS types are the same by each range of the elevation angle on the basis of the satellite signal data stored in the signal data storage unit 160, and extracts the maximum values of the CNRs of respective groups.

FIG. 8 illustrates an example of processing of S203 in a certain GNSS type. In the example of FIG. 8, the elevation angles are grouped into 0° to 15°, 15° to 30°, 30° to 45°, 45° to 60°, 60° to 75°, and 75° to 90° and the maximum values of the CNRs of the respective groups are extracted.

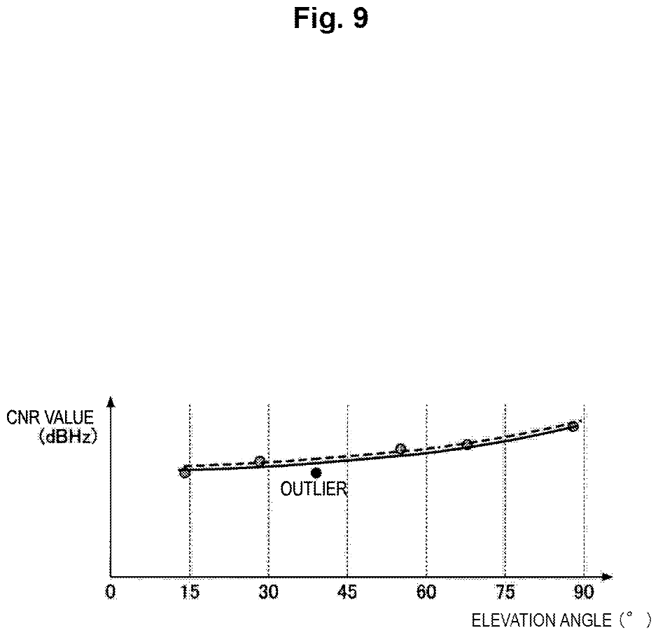

In S204, the bias value setting unit 170 applies curve fitting to extracted maximum value data by, for example, a nonlinear least squares method. In S205, the bias value setting unit 170 repeats curve fitting from which the greatest outlier is excluded several times. FIG. 9 illustrates an example of S204 and S205 for a GNSS type illustrated in FIG. 8.

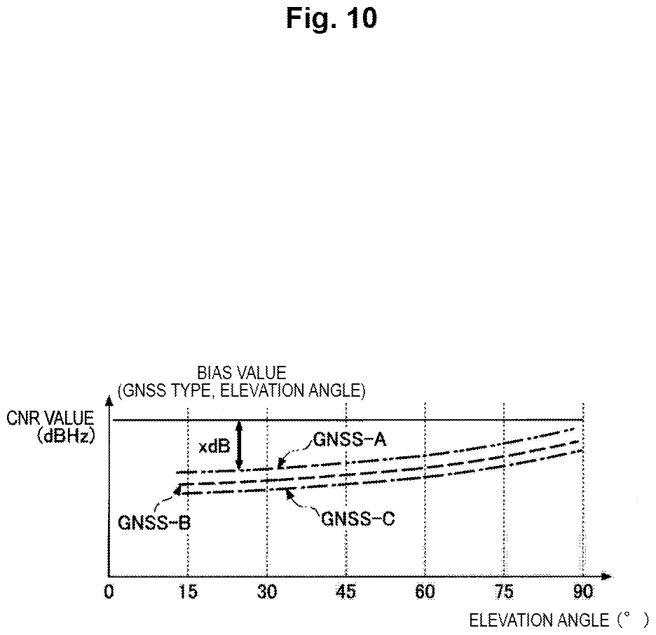

In S206, the bias value setting unit 170 generates fitting functions for respective GNSS types, and in S207, sets bias values of GNSS types and elevation angles by the fitting functions of the respective GNSS types. An example of S206 and S207 is illustrated in FIG. 10. As illustrated in FIG. 10, in any GNSS type, a greater bias value is set as the elevation angle is smaller. Furthermore, in the example of FIG. 10, among GNSS types, bias values greater in the order of GNSS-C>GNSS-B>GNSS-A are set.

(Setting Value of dCNR)

Next, a setting value of a dCNR (referred to as dCNR value) will be described. As described in S103 of FIG. 2, the dCNR value is a parameter by which a range of CNR values for selecting satellite signals is determined. Although the dCNR value may be a fixed value that does not depend on the elevation angle of a satellite signal, an example in which the dCNR value is determined depending on the elevation angle of a satellite signal will be described below. The example described here is an example on the assumption of a case where a reflecting surface of a satellite signal is a vertical wall surface of a building (concrete or glass), as in an urban area.

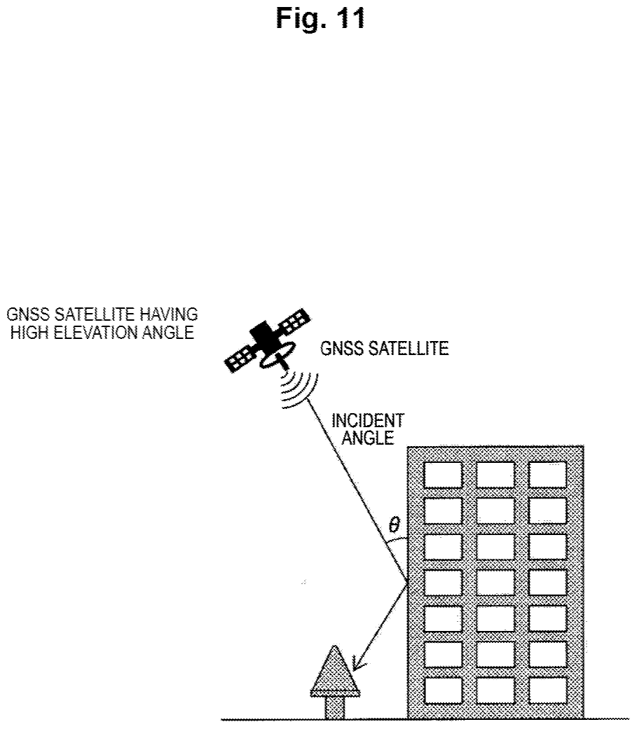

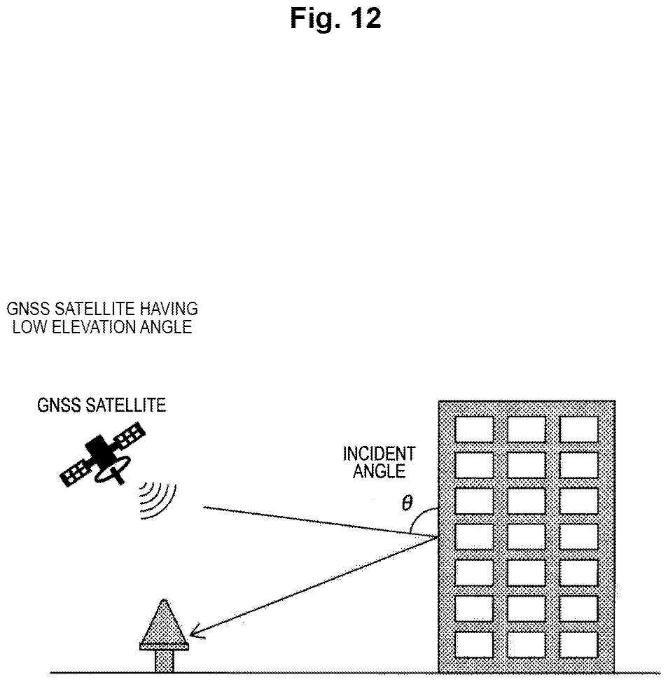

FIG. 11 illustrates a state in which a satellite signal having a high elevation angle is incident on and reflected by a vertical wall surface of a building, and FIG. 12 illustrates a state in which a satellite signal having a low elevation angle is incident on and reflected by a vertical wall surface of a building. As illustrated in FIGS. 11 and 12, the incident angle at which the satellite signal having a low elevation angle is incident on the vertical wall surface of the building is greater than the incident angle at which the satellite signal having a high elevation angle is incident on the vertical wall surface of the building.

Since the reflectance of a satellite signal by the vertical wall surface of the building depends on the incident angle, the satellite signal having a low elevation angle is expected to have a relatively high reflectance (the signal intensity of a reflected wave is high) as compared with the satellite signal having a high elevation angle.

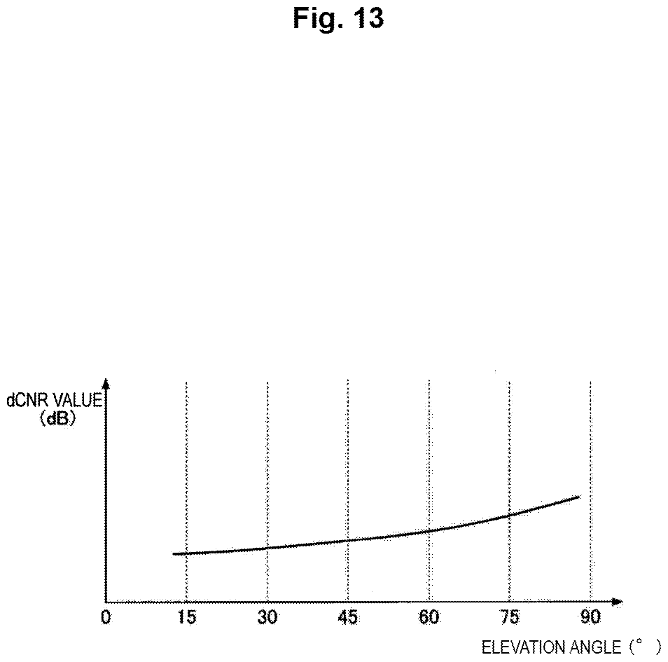

Therefore, giving elevation angle dependency to the dCNR value is effective in visible and invisible satellite selection. FIG. 13 illustrates a setting example of the dCNR value to which the elevation angle dependency is given. As illustrated in FIG. 13, when the elevation angle of a satellite signal increases, the dCNR value is also set to increase. A setting value having such elevation angle dependency may be stored, for example, in the bias value storage unit 180 in form of a function corresponding to a curve in FIG. 13, or may be stored in the bias value storage unit 180 in form of a table in which dCNR values for respective elevation angles (for example, in increments of 5°) are held.

When determining whether the CNR value of a certain satellite signal satisfies “CNR₀-dCNR<CNR<CNR₀” in S103 described above, the signal selection unit 130 refers to the bias value storage unit 180, acquires a dCNR value corresponding to the elevation angle of the satellite signal, and determines whether the CNR value satisfies “CNR₀-dCNR<CNR<CNR₀” using the dCNR value.

Furthermore, in the substitute satellite signal selection in S105 described above, when determining whether the CNR value of a certain satellite signal is less than or equal to “CNR₀-dCNR”, the signal selection unit 130 refers to the bias value storage unit 180, acquires a dCNR value corresponding to the elevation angle of the satellite signal, and determines whether the CNR value is less than or equal to “CNR₀-dCNR” using the dCNR value.

In the determination as to whether to select a satellite signal using “CNR₀-dCNR<CNR<CNR₀”, since the dCNR value of a satellite signal having a low elevation angle is smaller than that of a satellite signal having a high elevation angle, the range of “CNR₀-dCNR<CNR<CNR₀” of the satellite signal having a low elevation angle is narrower than that of the satellite signal having a high elevation angle. That is, filtering is performed more strictly on a satellite signal having a low elevation angle than on a satellite signal having a high elevation angle. The reason why the elevation angle dependency is given to a dCNR value such that a satellite signal having a low elevation angle is more strictly filtered than a satellite signal having a high elevation angle will be described below.

Assuming that the reflection surface of a satellite signal is a vertical wall surface of a building (concrete or glass) in an urban area, a satellite signal having a low elevation angle is in a state close to total reflection, and a difference between signal intensity of the reflected satellite signal and signal intensity in a case where there is no obstacle and the signal is received as a direct wave (reference signal intensity normalized by bias values of FIGS. 4 and 5) is small.

That is, the signal intensity is decreased in a case where a satellite signal having a low elevation angle is received as a direct wave because the optical path length of a medium that attenuates signal intensity such as an ionosphere or a troposphere is longer. On the other hand, a decrease in signal intensity in a case where the satellite signal is reflected by a building is small, and thus, in order to remove a multipath signal (reflected wave) of an invisible satellite signal, a decrease in dCNR value and strict filtering are required. A high elevation angle satellite is reversed, and is more likely to be selected by the range of “CNR₀-dCNR<CNR<CNR₀” being widened.

Note that giving elevation angle dependency such that a dCNR value increases as the elevation angle of a satellite signal increases is an example. Depending on the environment, elevation angle dependency different from the above may be given to a dCNR value.

Note that performing satellite selection in each satellite type unit is conceivable, but this is not performed. The reason is as follows.

The techniques according to the present invention is based on a premise that there is at least one visible satellite. In a case where satellite selection is performed in units of satellite types, if there is no visible satellite in a certain satellite type, the reference CNR value (CNR0) would be an inappropriate value, and there is a possibility that accuracy of satellite selection deteriorates. In a case where all satellite types are targeted as in the first and second embodiments, the probability that there is at least one visible satellite is improved.

### Second Embodiment

Next, a second embodiment will be described. The second embodiment is different from the first embodiment in that a measurement device 100 selects satellite signals for each frequency band. That is, in the first embodiment, satellite signals are selected only for the L1 band as an example, but in the second embodiment, satellite signals are selected for each of a plurality of frequency bands output from each satellite.

Note that the effect of the invention can be exhibited by the techniques described in the first embodiment. The second embodiment is a variation of the embodiments of the invention. In the second embodiment, the reason for selecting satellite signals for each frequency band is as follows.

Since each satellite outputs signals of a plurality of frequency bands, from the viewpoint of selecting satellites suitable for positioning according to the position (visible or invisible) of the satellite, satellite selection using signals of each of the plurality of frequency bands does not need to be performed as long as the visible or invisible state of the satellite can be accurately determined by satellite signals of any one frequency band.

However, in practice, whether the satellite is visible/invisible may not be determined with 100% accuracy. Furthermore, there is a possibility that reception characteristics of an antenna and a receiver and a mixed state of an interference signal are different for each frequency band, and there is a possibility that a combination of satellite signals more suitable for positioning calculation is selected by satellite signals being selected in each of the plurality of frequency bands.

In the positioning calculation, different satellite signals can be used for each frequency band. Since frequency bands supported by satellites are different (for example, the L5 frequency band of GPS corresponds to only some satellites), by satellite signals being individually selected for each frequency band, a variation of policy setting for positioning calculation (such as changing a No value for each frequency band) can be widened.

### Device Configuration

A device configuration of the measurement device 100 in the second embodiment is the same as the device configuration in the first embodiment, and is as illustrated in FIG. 1. Operations of the respective units are basically the same as those in the first embodiment, but are different from those in the first embodiment in that operations for selecting satellite signals are performed for each frequency band.

That is, for each frequency band, a signal reception unit 120 transmits identification information of received satellite signals (PRN numbers), the elevation angles, the CNRs, and the satellite types of the satellite signals to a signal selection unit 130. Furthermore, for each frequency band, the signal reception unit 120 stores the identification information, the elevation angles, the CNRs, and the satellite types for the respective received satellite signals in a signal data storage unit 160. In the present embodiment, the L1 band and the L2 band are targeted as the plurality of frequency bands. However, the use of the L1 band and the L2 band is an example, and in addition to these, the L5 band may be used, or a frequency band other than the L1 band, the L2 band, and the L5 band may be used.

### Operation Example of Signal Selection Unit 130

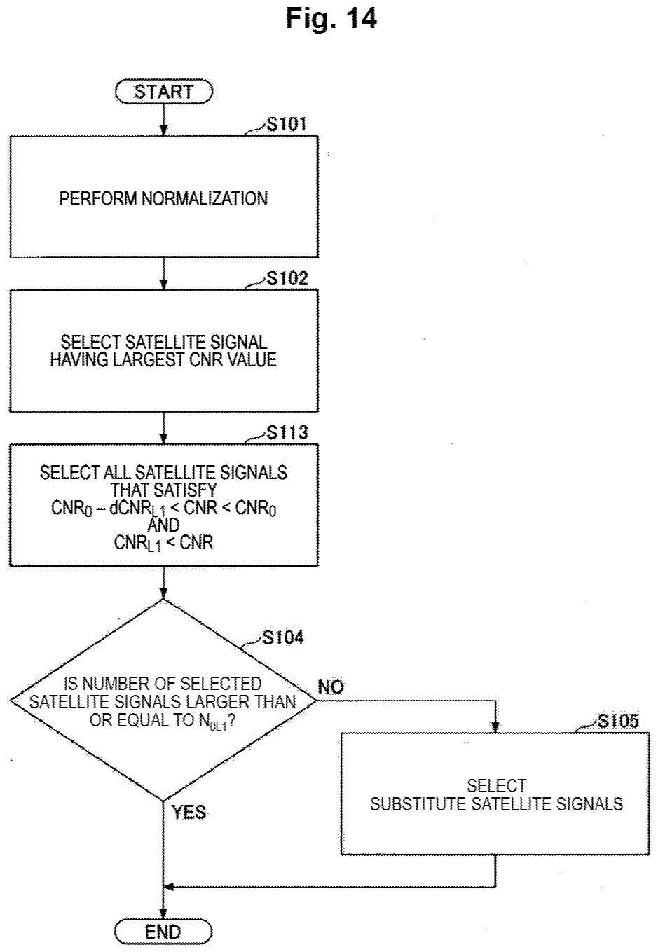

Next, an operation example of the signal selection unit 130 in the second embodiment will be described. FIG. 14 is a flowchart illustrating operations of the signal selection unit 130. The flow is basically the same as the flow in the first embodiment illustrated in FIG. 2, but the second embodiment is different from the first embodiment in that the flow in FIG. 14 is repeated for each frequency band, and whether the lowest CNR value in a frequency band being processed is satisfied is determined in S113 (corresponding to S103 in FIG. 2). Note that FIG. 14 illustrates processing for the L1 band in repetition for each frequency band as an example.

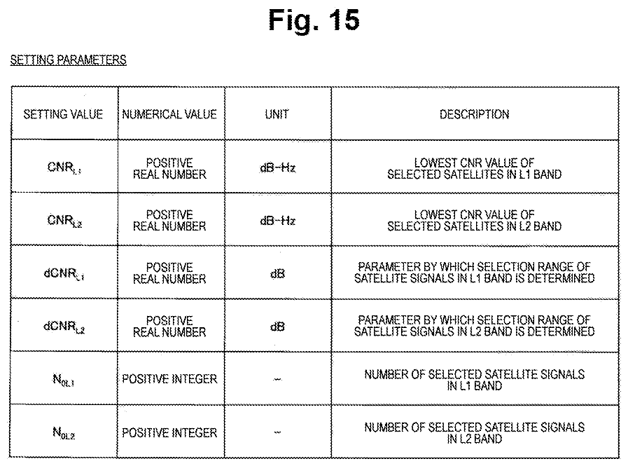

First, setting parameters used in a procedure in the second embodiment will be described with reference to FIG. 15. As illustrated in FIG. 15, CNR_{L1}, is the lowest CNR value of selected satellites in the L1 band. dCNR_{L1} is a parameter by which a selection range of satellite signals in the L1 band is determined. N_{0L1} is the number of selected satellite signals in the L1 band. Similar parameters are set for the L2 band. Note that, in a case where other frequency bands are used, parameters may be set for each frequency band. For example, in the case of the L5 band, CNR_{L5} and the like are set.

First, processing of the flow of FIG. 14 is performed for the L1 band. Processing of S101 and S102 is the same as that of the first embodiment. However, in the second embodiment, bias values as illustrated in FIGS. 4 and 5 are set for each frequency band, and in normalization processing of S101, normalization is performed using bias values corresponding to a frequency band being processed. In S102, a satellite signal having the greatest CNR value is selected from all satellite signals received in the corresponding frequency band (initially L1 band), and records the CNR value as CNR₀.

In S113, the signal selection unit 130, for the CNR value (CNR₀) of the satellite signal selected in S102, sets a value dCNR_{L1} (for example, 10 dB) smaller than CNR₀ as a lower limit of the CNR, and selects satellite signals that satisfy a condition from the received satellite signals. Here, the signal selection unit 130 selects all satellite signals having CNR values that satisfy CNR₀-dCNR_{L1}<CNR<CNR₀, and CNR_{L1}<CNR from all the satellite signals received in the L1 band.

In S104, the signal selection unit 130 determines whether the number of satellite signals selected in S102 and S103 is greater than or equal to a preset minimum selected satellite signal number (N_{0L1}). In a case where the determination result in S104 is Yes, the signal selection processing by the signal selection unit 130 for the L1 band ends. The signal selection unit 130 notifies the measurement unit 140 of identification information of the selected satellite signals (codes such as PRN numbers), and the measurement unit 140 performs positioning and time synchronization using the selected satellite signals.

The signal selection unit 130 performs the processing of the flow of FIG. 14 for the next frequency band (for example, L2 band).

In a case where the determination result in S104 is No, that is, in a case where the number of the satellite signals selected in S102 and S103 is less than the preset minimum selected satellite signal number (N_{0L1}), the processing proceeds to S105.

Processing in S105 may be the same as the processing described in the first embodiment. That is, in S105, the signal selection unit 130 selects satellite signals in order from the satellite signal having the next-greatest CNR value that is less than or equal to “CNR₀-dCNR” on the basis of a preset priority order of GNSS types (for example, FIG. 6), and compensates for a lack so that the total number of selected satellite signals reaches the N_{0L1}.

Note that the setting of the priority order as illustrated in FIG. 6 may be determined for each frequency band. In that case, the signal selection unit 130 selects satellite signals using a priority order corresponding to the frequency band being processed.

As in the first embodiment, as the method for selecting substitute satellite signals in consideration of the priority order based on the reliability, a method for setting premiums (values to be added) to CNR values according to the priority order (or category of the reliability) and sequentially selecting the required number of satellite signals from the satellite signal having the greatest CNR value can be used.

For example, in the example of FIG. 6, the premium of a priority order 1 is 5, the premium of a priority order 2 is 4, the premium of a priority order 3 is 3, the premium of a priority order 4 is 2, and the premium of a priority order 5 is 1.

As an example, it is assumed that N_{0L1} is 5, and three satellite signals are selected in S102 and S103. Furthermore, assuming that there are a satellite signal 1 (CNR value=26 dB-Hz, premium=1), a satellite signal 2 (CNR value=25 dB-Hz, premium=3), and a satellite signal 3 (CNR value=24 dB-Hz, premium=5) as satellite signals having CNR values less than or equal to “CNR₀-dCNR_{L1}”, in S105, the signal selection unit 130 selects the satellite signal 3 and the satellite signal 2 having CNR values of 29 dB-Hz and 28 dB-Hz to which premiums are added.

When S105 ends, the signal selection unit 130 notifies the measurement unit 140 of identification information of the selected satellite signals (codes such as PRN numbers), and the measurement unit 140 performs positioning and time synchronization using the selected satellite signals.

The signal selection unit 130 performs the processing of the flow of FIG. 14 for the next frequency band (for example, L2 band).

Note that, in the above example, positioning and time synchronization are performed using selected satellite signals for each frequency band, but positioning and time synchronization using satellite signals of the plurality of frequency band may be performed on the basis of satellite signals selected in a specific frequency band.

For example, in a case where satellite signals 1, 2, 3, and 4 are selected in the L1 band and satellite signals 5, 6, 7, and 8 are selected in the L2 band by the flow of FIG. 14 being performed for each of the L1 band and the L2 band, a dilution of precision (DOP) value of the satellite signals 1, 2, 3, and 4 are compared with a DOP value of the satellite signals 5, 6, 7, and 8, and satellite signals of a frequency band having a smaller DOP value are selected, and positioning and time synchronization using signals of the L1 band and the L2 band may be performed.

### Variation of Method for Selecting Substitute Satellite Signal

Another example of the selection of a substitute satellite signal in S105 will be described. The signal selection unit 130 may select a substitute satellite signal in consideration of a DOP value. For example, the signal selection unit 130 selects satellite signals A, B, and C as substitute satellite signal possibilities in order from the satellite signal having the next-greatest CNR value that is less than or equal to “CNR₀-dCNR”, calculates a DOP value in a case where each of the substitute satellite possibilities A, B, and C is added to already selected satellite signals, and selects the satellite signals that makes the DOP value the smallest.

For example, assuming that the satellite signals already selected at the time of S104 are satellite signals 1, 2, and 3, DOP values of “satellite signals 1, 2, 3, A”, “satellite signals 1, 2, 3, B”, and “satellite signals 1, 2, 3, C” are calculated. If a DOP value of the “satellite signals 1, 2, 3, A” is the smallest, the “satellite signals 1, 2, 3, A” are selected. In a case where the number of satellites to be selected is greater than four, the above processing may be repeated until the number of satellites is reached.

Here, the method for selecting a substitute satellite signal described in the first embodiment is referred to as a selection method 1, and the above method in which a DOP value is used is referred to as a selection method 2. The signal selection unit 130 may select a substitute satellite signal by a combination of selection methods 1 and 2.

As an example of the combination, substitute satellite signals are selected by the selection method 1, the selection method 2 is performed on each of the selected satellite signals, and a satellite signal that makes the DOP value small is selected.

Furthermore, for example, cost values (evaluation values) may be set using the degree of improvement in positioning accuracy by satellite signals selected on the basis of the selection methods 1 and 2 as expected values, and a satellite signal having the smallest total cost value (evaluation value) of the selection methods 1 and 2 may be selected as a substitute satellite signal. For example, it is assumed that a satellite signal A and a satellite signal B are selected as substitute satellite signal possibilities by the combination of the selection methods 1 and 2. For example, it is assumed that the CNR value of the satellite signal A is 30 dB-Hz, the CNR value of the satellite signal B is 28 dB-Hz, a DOP value in a case where the satellite signal A is selected is 5, and a DOP value in a case where the satellite signal B is selected is 4. In a case where a total cost value (evaluation value) of the selection methods 1 and 2 is set to DOP value/CNR value, since the cost values of satellite signals A and B are 1/6 and 1/7, respectively, and the satellite signal B is smaller than the satellite signal A, the satellite signal B is selected as a substitute satellite signal.

### Operation Example Regarding Bias Value Setting

In the second embodiment, bias value setting operation performed by a bias value setting unit 170 is basically the same as the bias value setting operation in the first embodiment, but the second embodiment is different from the first embodiment in that bias values are set for each frequency band.

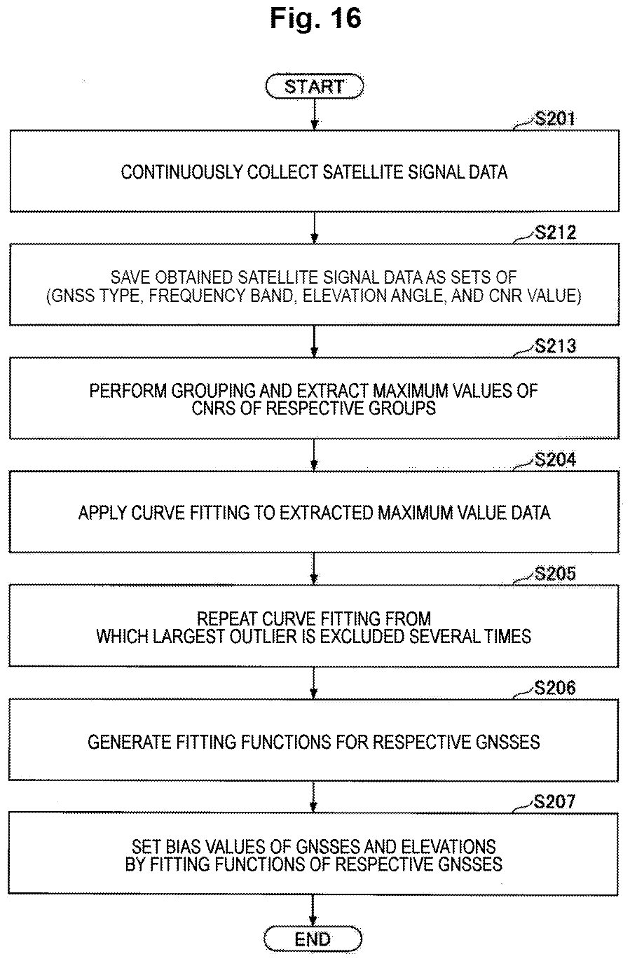

FIG. 16 is a flowchart of the bias value setting operation according to the second embodiment. In S201, the signal reception unit 120 continuously collects satellite signal data for each frequency band.

In S212, the collected satellite signal data is stored in the signal data storage unit 160 as sets of (a GNSS type, a frequency band, an elevation angle, and a CNR value).

In S213, the bias value setting unit 170 groups data in which the GNSS types and frequency bands are the same by each range of the elevation angle on the basis of the satellite signal data stored in the signal data storage unit 160, and extracts the maximum values of the CNRs of respective groups. The processing example is as described with reference to FIG. 8.

In S204, the bias value setting unit 170 applies curve fitting to extracted maximum value data by a nonlinear least squares method or the like. In S205, the bias value setting unit 170 repeats curve fitting from which the greatest outlier is excluded several times. The example of S204 and S205 for a GNSS type illustrated in FIG. 8 is as illustrated in FIG. 9.

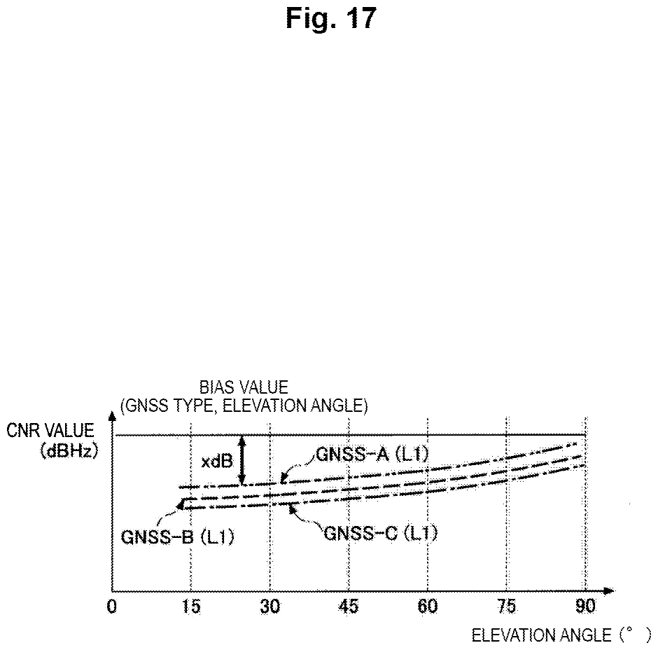

In S206, the bias value setting unit 170 generates fitting functions for respective GNSS types, and in S207, sets bias values of GNSS types and elevation angles by the fitting functions of the respective GNSS types. FIG. 17 illustrates an example of S206 and S207 for the L1 band.

As described above, in the second embodiment, bias values are set for each frequency band of satellite signals (for example, in a case of GPS, L1 band, L2 band, and L5 band) for each GNSS satellite type. This is because the reception characteristic of a satellite signal depends on the frequency band of the satellite signal in addition to the GNSS satellite type and the elevation angle. Note that bias values based only on the GNSS satellite type and frequency band may be set without using the elevation angle.

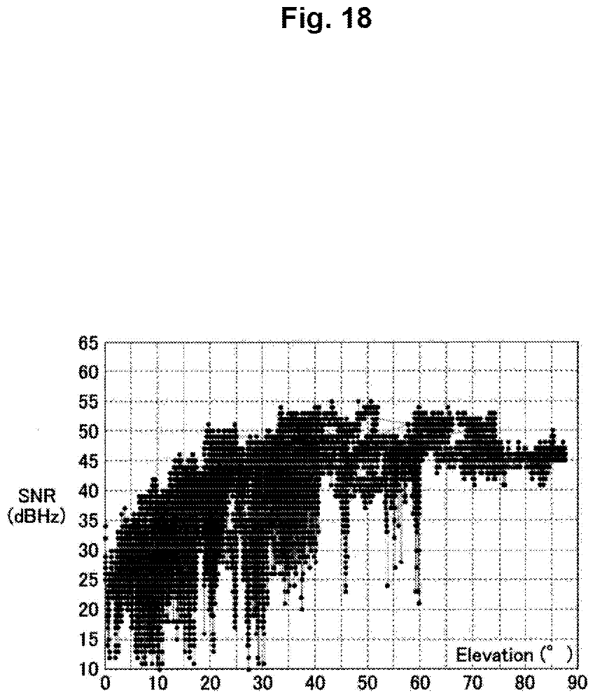

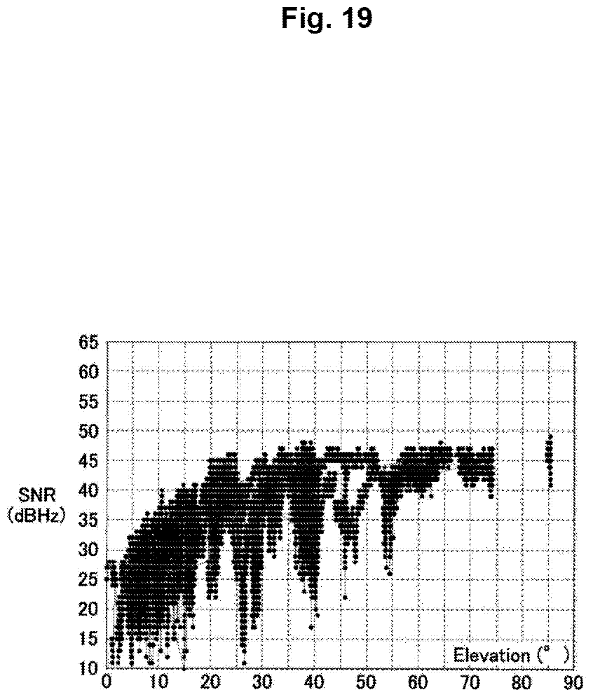

FIGS. 18 and 19 illustrate actual measurement examples of a difference in reception characteristics that depends on the frequency band for the same combination of a GNSS antenna and a GNSS receiver. FIG. 18 illustrates an L1 signal of GPS, and FIG. 19 illustrates a L2 signal of GPS. In both FIGS. 18 and 19, the horizontal axis represents the elevation angle (°), and the vertical axis represents the CNR (SNR) value (dB-Hz).

### Variation Regarding Bias Value Setting

Even in the same GNSS type, transmission signal output may be different depending on the individual satellite. For example, the transmission signal output may be different depending on the orbit of a satellite (GEO/IGSO/MEO). In this case, bias values may be set for an individual satellite.

For example, in a case where the transmission signal intensity of the satellite A is smaller than the signal intensity of another satellite of the same GNSS type, the reception signal intensity decreases and the satellite signal may not be selected even in a case where the signal is received as a direct wave. In this case, correction in which an individual bias value is added to the reception quality is performed on the satellite signal at the time of normalization. The individual bias value is applied in addition to the GNSS bias value and the elevation angle bias value illustrated in FIGS. 4 and 5. Alternatively, only the individual bias value may be applied to a satellite signal to which the individual bias value is applied without the GNSS bias value and the elevation angle bias value being applied. Alternatively, the elevation angle bias value and the individual bias value may be applied to a satellite signal to which the individual bias value is applied without the GNSS bias value being applied.

As to which satellite of which GNSS type the individual bias value is set, for example, the reception signal intensity is measured in advance for satellites of each GNSS type, and the measured values are stored in the signal data storage unit 160, and the bias value setting unit 170 selects a satellite in which an event similar to that of the satellite A described above occurs, and sets an individual bias value for the selected satellite.

Furthermore, an individual bias value for a specific satellite may be applied to a case other than the case regarding transmission signal output as in the satellite A described above.

### Setting Value of dCNR

Also regarding dCNR values for respective frequency bands in the second embodiment, as described with reference to FIGS. 11 and 12, dCNR values to which elevation angle dependency is given may be set. In this case, for example, the dCNR values to which the elevation angle dependency is given as illustrated in FIG. 13 are set for the respective frequency bands.

### Hardware Configuration Example

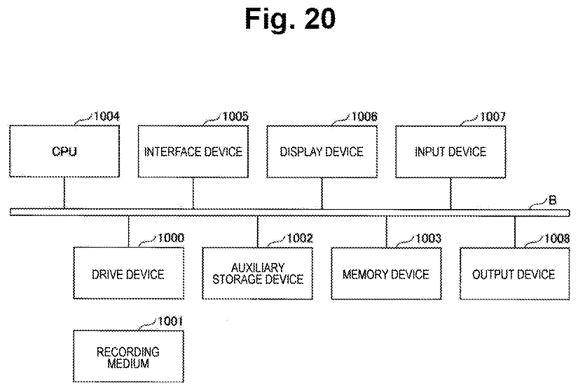

FIG. 20 is a diagram illustrating a hardware configuration example of a computer that can be used as the measurement device 100 in the first and second embodiments. The computer may be a computer as a physical device or a virtual machine on the cloud.

The computer in FIG. 20 includes a drive device 1000, an auxiliary storage device 1002, a memory device 1003, a central processing unit (CPU) 1004, an interface device 1005, a display device 1006, an input device 1007, an output device 1008, and the like, which are connected to each other by a bus B. Note that the GNSS antenna 110 is not illustrated in FIG. 20. The GNSS antenna 110 is connected to, for example, the interface device 1005.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the measurement device 100 in accordance with a program stored in the memory device 1003. The interface device 1005 is used as an interface for connecting to the GNSS antenna 110. The display device 1006 displays a graphical user interface (GUI) or the like by the program. The input device 1007 includes a keyboard and mouse, buttons, a touch panel, or the like, and is used to input various operation instructions. The output device 1008 outputs a calculation result.

### Effects of Embodiments

As described above, according to the embodiments of the present invention described in the first and second embodiments, the reference value (CNR₀) of reception quality is measured in order to reflect a variation in reception quality that depends on the characteristics of a device to be used and superimposition of an interference signal, and satellite signals are selected in consideration of reception quality that depends on the satellite type and the elevation angle, whereby positioning and time synchronization by GNSS can be accurately performed even in a case where the reception environment of satellite signals is not good.

### Summary of Embodiments

In the present embodiment, at least the measurement device, the measurement method, and the program described in the following clauses are provided.

### Clause 1

A satellite signal reception device including a signal selection unit that selects a predetermined number of satellite signals on the basis of reception quality of satellite signals received by a GNSS antenna, and a measurement unit that performs positioning or time synchronization using the predetermined number of satellite signals selected by the signal selection unit.

### Clause 2

The satellite signal reception device according to clause 1, in which the signal selection unit normalizes reception quality measured from received satellite signals on the basis of GNSS types, frequency bands, or elevation angles of satellite signals, and selects the predetermined number of satellite signals using reception quality after normalization.

### Clause 3

The satellite signal reception device according to clause 2, in which the signal selection unit performs the normalization by adding preset bias values on the basis of GNSS types or elevation angles of satellite signals to reception quality measured from received satellite signals.

### Clause 4

The satellite signal reception device according to clause 3 further including a bias value setting unit that obtains fitting functions for an elevation angle and reception quality for frequency bands of each GNSS type on a basis of GNSS types, frequency bands, elevation angles, and reception quality of collected satellite signals, and sets the bias values using obtained fitting functions.

### Clause 5

The satellite signal reception device according to any one of clauses 1 to 4, in which the signal selection unit normalizes reception quality of a satellite signal received from a specific satellite by adding a preset individual bias value to the specific satellite, and selects the predetermined number of satellite signals using reception quality after normalization.

### Clause 6

The satellite signal reception device according to any one of clauses 1 to 5, in which the signal selection unit selects a satellite signal having best reception quality from all received satellite signals, and, using a value obtained by subtracting a predetermined value from a value of the best reception quality as a lower limit, selects all satellite signals having reception quality better than the lower limit.

### Clause 7

The satellite signal reception device according to any one of clauses 1 to 5, in which the signal selection unit selects a satellite signal having best reception quality from all received satellite signals, and, using a value obtained by subtracting a predetermined value from a value of the best reception quality as a lower limit, selects all satellite signals having reception quality better than the lower limit and preset minimum reception quality.

### Clause 8

The satellite signal reception device according to clause 6 or 7, in which, when determining whether to select a certain satellite signal, the signal selection unit uses a value that depends on an elevation angle of the satellite signal as the predetermined value.

### Clause 9

The satellite signal reception device according to any one of clauses 1 to 8, in which, in a case where a total number of a satellite signal having the best reception quality and all satellite signals having reception quality better than the lower limit is less than the predetermined number, the signal selection unit selects a satellite signal having reception quality lower than or equal to the lower limit on the basis of a priority order of GNSS types so that a total number of selected satellite signals reaches the predetermined number.

### Clause 10

The satellite signal reception device according to any one of clauses 6 to 9, in which, in a case where a total number of a satellite signal having the best reception quality and all satellite signals having reception quality better than the lower limit is less than the predetermined number, the signal selection unit selects a satellite signal having reception quality lower than or equal to the lower limit on the basis of a DOP value so that a total number of selected satellite signals reaches the predetermined number.

### Clause 11

A satellite signal processing method performed by a satellite signal reception device, including a signal selection step for selecting a predetermined number of satellite signals on the basis of reception quality of satellite signals received by a GNSS antenna, and a measurement step for performing positioning or time synchronization using the predetermined number of satellite signals selected by the signal selection step.

### Clause 12

A program for causing a computer to function as the respective units in the satellite signal reception device according to any one of clauses 1 to 10.

Although the present embodiments have been described above, the present invention is not limited to such specific embodiments, and various modifications and changes can be made within the scope of the gist of the present invention described in the claims.

The present patent application claims the priority based on International Application PCT/JP2020/043044 filed on Nov. 18, 2020 and International Application PCT/JP2021/020391 filed on May 28, 2021, and the entire contents of International Application PCT/JP2020/043044 and International Application PCT/JP2021/020391 are incorporated herein by reference.

### REFERENCE SIGNS LIST

100 Measurement device
110 GNSS antenna
120 Signal reception unit
130 Signal selection unit
140 Measurement unit
150 Output unit
160 Signal data storage unit
170 Bias value setting unit
180 Bias value storage unit
1000 Drive device
1001 Recording medium
1002 Auxiliary storage device
1003 Memory device
1004 CPU
1005 Interface device
1006 Display device
1007 Input device
1008 Output device

1. A satellite signal reception device comprising:
a memory; and
a processor configured to execute:
Selecting a predetermined number of satellite signals on a basis of reception quality of satellite signals received by a GNSS antenna; and
performing positioning or time synchronization using the predetermined number of satellite signals selected by the selecting.

2. The satellite signal reception device according to claim 1, wherein the selecting normalizes reception quality measured from received satellite signals on a basis of GNSS types, frequency bands, or elevation angles of satellite signals, and selects the predetermined number of satellite signals using reception quality after normalization.

3. The satellite signal reception device according to claim 2, wherein the selecting performs the normalization by adding preset bias values on a basis of GNSS types, frequency bands, or elevation angles of satellite signals to reception quality measured from received satellite signals.

4. The satellite signal reception device according to claim 3, wherein the processor is further configured to execute:
obtaining fitting functions for an elevation angle and reception quality for frequency bands of each GNSS type on a basis of GNSS types, frequency bands, elevation angles, and reception quality of collected satellite signals, and sets the bias values using obtained fitting functions.

5. The satellite signal reception device according to claim 1, wherein the selecting normalizes reception quality of a satellite signal received from a specific satellite by adding a preset individual bias value to the specific satellite, and selects the predetermined number of satellite signals using reception quality after normalization.

6. The satellite signal reception device according to claim 1, wherein the selecting selects a satellite signal having best reception quality from all received satellite signals, and, using a value obtained by subtracting a predetermined value from a value of the best reception quality as a lower limit, selects all satellite signals having reception quality better than the lower limit.

7. The satellite signal reception device according to claim 1, wherein the selecting selects a satellite signal having best reception quality from all received satellite signals, and, using a value obtained by subtracting a predetermined value from a value of the best reception quality as a lower limit, selects all satellite signals having reception quality better than the lower limit and preset minimum reception quality.

8. The satellite signal reception device according to claim 6, wherein, when determining whether to select a certain satellite signal, the selecting uses a value that depends on an elevation angle of the satellite signal as the predetermined value.

9. The satellite signal reception device according to claim 6, wherein, in a case where a total number of satellite signals having the best reception quality and all satellite signals having reception quality better than the lower limit is less than the predetermined number, the selecting selects a satellite signal having reception quality lower than or equal to the lower limit on a basis of a priority order of GNSS types so that a total number of selected satellite signals reaches the predetermined number.

10. The satellite signal reception device according to claim 6, wherein, in a case where a total number of satellite signals having the best reception quality and all satellite signals having reception quality better than the lower limit is less than the predetermined number, the selecting selects a satellite signal having reception quality lower than or equal to the lower limit on a basis of a DOP value so that a total number of selected satellite signals reaches the predetermined number.

11. A satellite signal processing method performed by a satellite signal reception device including a memory and a processor, the method comprising:
selecting a predetermined number of satellite signals on a basis of reception quality of satellite signals received by a GNSS antenna; and
performing positioning or time synchronization using the predetermined number of satellite signals selected by the signal selection step.

12. A non-transitory computer-readable recording medium having computer-readable instructions stored thereon, which when executed, cause a computer to function as the satellite signal reception device according to claim 1.
